(19) United States
(12) Patent Application Publication
(10) Pub. No.: US 2012/0253851 A1
(43) Pub. Date: Oct. 4, 2012

(54) System And Method For Controlling Displaying Medical Record Information On A Secondary Display

(76) Inventors: Stephan L. Phillips, Madison, WI (US); Glenn A. Loos-Austin, Madison, WI (US); Robert A. Szymanski, Madison, WI (US); Medhat Assaad, Sun Prairie, WI (US); Ashley N. Wright, Madison, WI (US); Sagnik Bhattacharya, Madison, WI (US); Joshua M. Brauer, Madison, WI (US)

(21) Appl. No.: 13/495,393

(22) Filed: Jun. 13, 2012

Related U.S. Application Data
(63) Continuation-in-part of application No. 13/033,968, filed on Feb. 24, 2011.

(51) Int. Cl. G06Q 50/24

(52) U.S. Cl. 705/3

(57) ABSTRACT

A computer implemented method for displaying patient medical data during an interaction between a patient and a healthcare provider. The method includes receiving an identification of a patient at an electronic medical record server and transmitting patient medical data from an electronic medical record associated with the identified patient to the healthcare provider computing device. The method further includes identifying a location of the provider computing device, transmitting an activation key to a secondary display device for display on the secondary display device, and receiving confirmation from the healthcare provider computing device that the activation key was entered into the healthcare provider computing device. Following activation, the method includes displaying information from the electronic medical record on the secondary display based on a command received from the healthcare provider computing device.

### CROSS-REFERENCE TO RELATED APPLICATION

This application claims the benefit of U.S. patent application Ser. No. 13/033,968 filed Feb. 24, 2011, which is hereby incorporated by reference.

### FIELD OF THE INVENTION

The present invention relates to portable computing devices providing an interface to an electronic medical records system and, in particular, to a portable computing device used by a physician to interact with data in an electronic medical record including communicating with a patient using a secondary display.

### BACKGROUND OF THE INVENTION

Healthcare provider interactions with patients can be one of the most important aspects of medical care. Interacting with the patient provides the best opportunity for the physician to both communicate and receive information that is used to provide medical care. For example, during a physician consult, the patient and physician exchange a large amount of information concerning the visit. For the physician, this amounts to details concerning the background of illness, patient history, and family members with similar problems. The patient in turn, becomes educated about his or her illness, and is presented options to tackle the problem along with various risks and side effects with each treatment option.

Given the large amount of information that is communicated between the physician and the patient, personal computing devices are often used in both the communication and recording of information regarding the interaction. For example, the physician will usually create a record of the patient's concerns and description of his or her symptoms. The record can be created during the interaction or afterward relying on the physician's memory or handwritten notes.

Further, physicians often use computer monitors or other displays to communicate information to the patient. The physician can use a computer to display an educational video, information graphics, X-rays, test results, etc. The physician often displays this information as a tool in helping the patient understand his or her condition and to reduce any anxiety over his or her condition.

However, traditional computing systems are not set up to facilitate patient physician interaction. For example, where the physician and the patient are, looking at the same display, the patient and physician are forced to turn shoulder to shoulder to view the same screen. Also, there is a conceptual wall put up between patient and physician when a physician has to spend time working on a computer, whether documenting or reading, that can interfere with the patient/physician interaction.

Further, when the patient and physician are looking at the same display, the physician must ensure that the only information that is provided on the display is appropriate for viewing by the patient. For example, where a test result has come back with results that can only be understood in context, it may be that the physician wants to explain the context to the patient prior to displaying the results since much of the information that a physician would need to reference is technical in nature. In this case, the physician can present the information in a measured presentation to avoid overwhelming the patient.

What is needed is a portable computing device interacting with a patient's electronic medical record that allows a healthcare provider to display selected information on a secondary display. What is further needed is such a device configured to, automatically configure the personal computing device specific to the patient interacting with the healthcare provider.

### SUMMARY OF THE INVENTION

The present inventors have recognized that a handheld computer, such as a tablet computer, can be used by a physician to greatly improve interactions with a patient using another display system. A physician entering a patient's room can have his or her handheld computer automatically associated with the patient's electronic medical record. Thereafter, the doctor can use the tablet computer to control the display of information from the EMR on the secondary display. Further, input provided on either the tablet computer or an input for the secondary display can be stored within the EMR.

Specifically, the invention provides a computer implemented system for displaying patient medical data during an interaction between a patient and a healthcare provider. The system includes a healthcare provider computing device configured to receive identification of a patient, a secondary display device, and an electronic medical record system server. The electronic medical record system server is configured to receive an identification of the patient transmitted from the healthcare provider computing device and provide access to patient medical data in an electronic medical record through the healthcare provider computing device, and display information from the electronic medical record on the secondary display based on a command received from the healthcare provider computing device.

It is thus a feature of at least one embodiment of the invention to provide such a system wherein the electronic medical record system is configured to transmit an activation key to the secondary display device for display on the secondary display device. The provider computing device is configured to receive entry of the activation key. Thereafter, information from the electronic medical record may be displayed on the secondary display.

It is also a feature of at least one embodiment of the invention to provide such a system wherein the information is medical image data and the medical image data is displayed on the provider computing device as well as the secondary display device. The provider computing device is configured to provide an annotation toolset for making modifications to the medical image data and modifications to the medical image data on the provider computing device are transmitted to the electronic medical record system server for storage in the electronic medical record. The modifications to the medical image data are displayed on the secondary display based on a selection by the user of the provider computing device. According to another embodiment, the secondary display device also provides an annotation toolset for making modifications to the medical image data.

It is also a feature of at least one embodiment of the invention to provide such a system wherein the provider computing device is configured to display a treatment plan template including a plurality of selectable treatment plan events and selection of a treatment plan event transmits a signal to the electronic medical record system server to display the treatment plan event on the secondary display device.

The invention further provides a computer implemented method for displaying patient medical data during an interaction between a patient and a healthcare provider. The method includes receiving an identification of a patient at an electronic medical record server and transmitting patient medical data from an electronic medical record associated with the identified patient to the healthcare provider computing device. The method further includes identifying a location of the provider computing device, transmitting an activation key to a secondary display device for display on the secondary display device, and receiving confirmation from the healthcare provider computing device that the activation key was entered into the healthcare provider computing device. Following activation, the method includes displaying information from the electronic medical record on the secondary display based on a command received from the healthcare provider computing device.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a healthcare provider communication system including a healthcare provider specific computing device in communication with an, electronic medical record system over a network to display information on a secondary display, according to an exemplary embodiment;

FIG. 2 is a flowchart illustrating a method for associating a provider device with a specific patient electronic medical record in an electronic medical record system and a secondary display, according to an exemplary embodiment;

FIG. 3 is an exemplary display screen for the provider device of FIG. 1 including a secondary display cursor control and an activation screen, according to an exemplary embodiment;

FIG. 4 is an exemplary patient roadmap interface to be displayed on the provider device of FIG. 1 during presentation of a treatment plan to a patient, according to an exemplary embodiment;

FIG. 5 is a an alternative patient roadmap interface from FIG. 4 and a second display interface to be displayed on the provider device and secondary display of FIG. 1, respectively to present a treatment plan to a patient, according to an exemplary embodiment; and

FIG. 6 is a diagram showing the provider device and secondary display device of FIG. 5 used to review patient medical images from the patient's electronic medical record, according to an exemplary embodiment.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENT

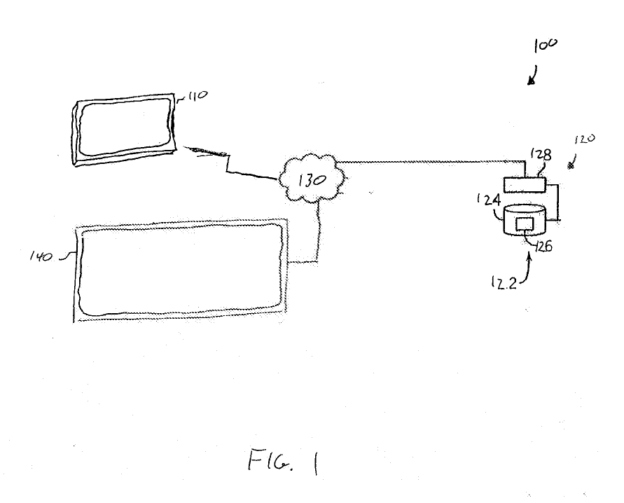

According to an exemplary embodiment, a tablet computer can be used by a physician to greatly improve his interaction with a patient using another display. Referring now to FIG. 1, a healthcare provider communication system 100 including a healthcare provider specific computing device 110, hereinafter provider device 110, in communication with an electronic medical record system 120 over a network 130 to display information on a secondary display 140 is shown, according to an exemplary embodiment. System 100 is generally configured for use in a hospital setting having a large number of patients but may also be implemented in physician offices, a clinical setting, etc.

Provider device 110 is preferably a tablet computing device, but may be implemented using a number of different types of computing systems such as handheld computing systems, smartphone based computing systems, glasses or contact lens based computing systems, etc. Provider device 110 may be a typical tablet computing device including a processor connected via an internal bus with a memory including, for example, volatile random access memory and nonvolatile mass storage memory such as flash memory or a hard disk drive. The bus may also communicate with one or more interfaces communicating respectively with a network media, for example a wireless network port, a microphone, a camera, a speaker, and a touchscreen interface. Provider device 110 may alternative be configured to not include nonvolatile mass storage and to utilize network interfaces to connect with a remote nonvolatile memory.

The electronic medical record system 120 includes a clinical database 122 providing a data storage system 124 holding a clinical record database 126 served by an electronic medical record server 128 to network 130, according to an exemplary embodiment. The electronic medical record server 128, for example, may be the EpicCare EMR manufactured by Epic Systems Corporation of Verona, Wis. As will be understood to those of ordinary skill in the art, a clinical record database 126 is one prepared under the supervision of healthcare professionals and having limited access per HIPAA requirements to provide a record keeping system on which health care decisions may be founded.

Electronic medical record system 120 includes an EMR specifically associated with a patient interacting with the user of provider device 110. The EMR may be an existing medical record including a developed medical history for the patient based on a series of interactions with healthcare providers. The medical history may include a record of patient interactions with the healthcare provider and the reasons for those interactions, medicine administrations, treatment administrations, laboratory results, allergy information, patient demographic and personal information, family information, etc. that would typically be found in a patient record. The medical record may further include patient sourced information such as patient notes, patient, generated medical information such as, for example, self-monitored blood pressure readings. The medical record may further include information imported from medical records associated with previous healthcare providers.

Network 130 may be any type of wired and/or wireless network for securely communicating information between devices and systems in system 100. Network 130 may further be configured to connect to external networks such as the Internet for additional sources of information.

Secondary display 140 may be any type of display for displaying high definition information at a high resolution. According to an exemplary embodiment, secondary display 140 may be a computing device including a processor, memory, network interface, input and output devices configured to receive instructions and to display information from electronic medical record system 120. Secondary display 140 may further be configured to receive inputs such as through a touch screen interface, a microphone, a camera, etc. In one exemplary embodiment, the camera can be used to control the operation of the device, such as the Kinect system manufactured by Microsoft, the Eye toy manufactured by Sony, etc.

In operation, provider device 110 is automatically associated with a particular patient having a medical record stored in the electronic medical record system 120 as described in further detail below. A doctor entering a patient's room will be provided with a tablet based interface to that patient's electronic medical record in electronic medical record system 120 and will further be presented with a control interface for manipulating that electronic medical record and displaying information from the record on the secondary display 140 in the patient's room.

Provider device 110 may further communicate directly with display 140 using, for example, a Bluetooth communication standard, near field communication, etc. Direct communication between device 110 and display 140 may be used for identification and to initiate communication, followed by interaction through network 130.

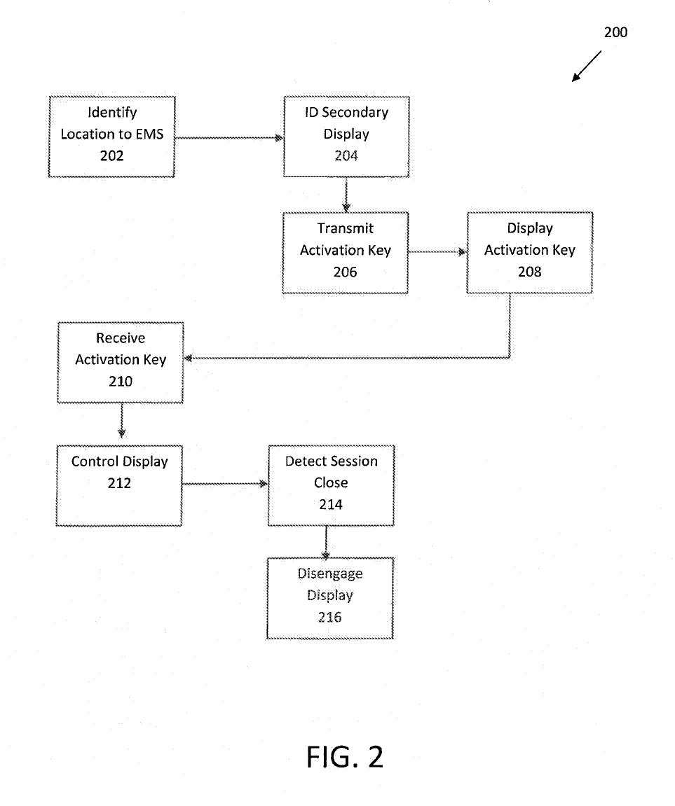

Referring now to FIG. 2, a flowchart 200 illustrates a method for associating a provider device 110 with a specific patient EMR in electronic medical record system 120 and secondary display 140, according to an exemplary embodiment. The method of flowchart 200 may be implemented through the device 110 in communication with electronic medical record system 120 based on inputs received at the secondary display 140.

In a first step 202, the location of device 110 may be identified to electronic medical record system 120. The location of device 110 may be performed using any of a number of different methods. Device 110 may determine its own location based on receiving a signal from a transmitter within a patient room, based on a schedule for the healthcare provider stored on the device 110, based on selection of a location icon on a mapping program showing, for example, a hospital floor layout, etc. The location of the device may alternatively be determined based on the location of the healthcare provider using the device, such as by using an RFID badge, a quick reference (QR) code identified with a specific location and received by a camera of the device, etc. The determined location of the device is then transmitted to the electronic medical record system 120.

Location of the device 110 within a patient room may be facilitated by displaying a location indicator on the device 110. The location indication may include displaying the room number that the device is located in, displaying the name and a photograph of the patient in the room, etc.

Following determination of a location, electronic medical record system 120 is configured to identify a secondary display 140 associated with the location of device 110 in a step 204. The secondary display 140 may be identified by using a lookup table. For example, a hospital may have a listing of secondary displays 140 located in patients room and may select a particular secondary display 140 when the healthcare provider is visiting with the patient in the room associated with the particular display.

Following identification, electronic medical record system 120 transmits an activation key to the secondary display 140 to provide control of the secondary display to the provider device 110 in a step 206. Prior to sending the activation key, the secondary display 140 may be in patient centric mode performing functions such as displaying the patient's daily schedule, showing entertainment options, etc.

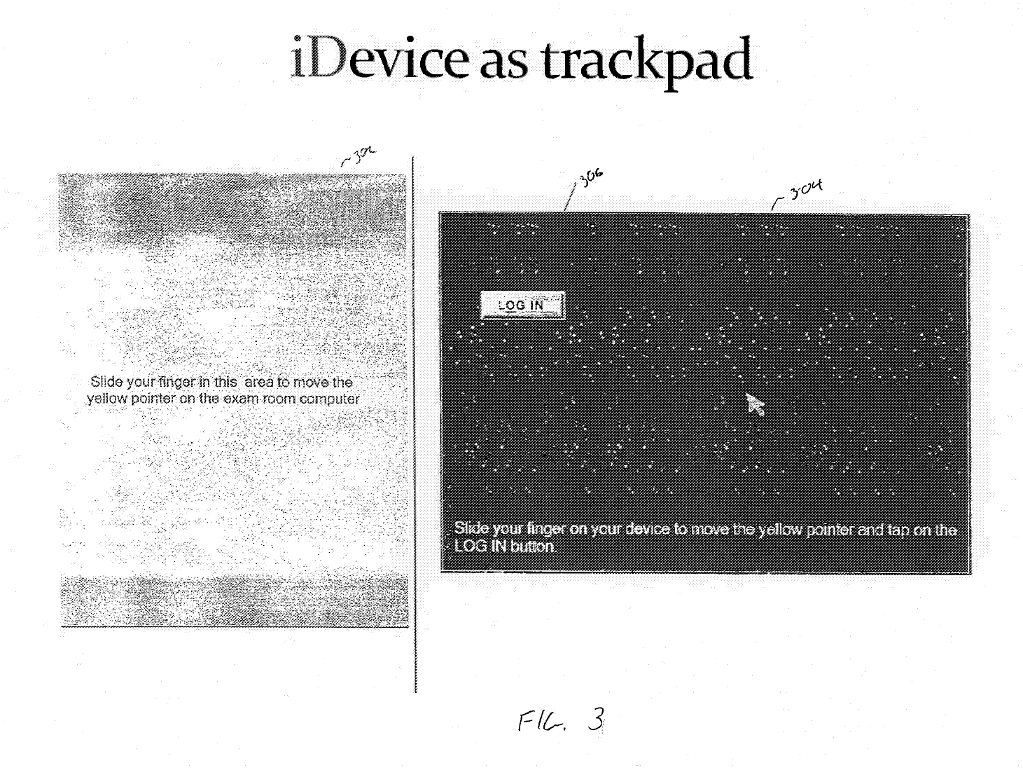

Upon receiving the activation key, display 140 displays a prompt that will allow the healthcare provider to enter the activation key to begin controlling the secondary display 140 in step 208. The activation key is displayed on the provider device 110 or may be a provider specific key code. The healthcare provider can provide the key using, for example, a touch screen interface on secondary display 140 in a step 210. Alternatively, the activation key may be displayed on display 140 for entry into device 110. Referring now also to FIG. 3, an exemplary display screen 400 for provider device 110 including a secondary display cursor control 302 and an activation screen 304 is shown, according to an exemplary embodiment. Screen 304 includes a log in icon 306 that allows the provider to initiate control of the secondary display 140. Following selection of the login in icon 306, activation screen 304 can be used to display the activation key. Thereafter, in one embodiment of the invention, display cursor control 302 may be used to control a mouse cursor displayed on the secondary display 140.

Following receipt of the key, provider device 110 can be used to control the information displayed on secondary display 140 in an ongoing step 212. In order to display information, provider device 110 sends display instructions to electronic medical record system 120 for secondary display 140. The information that is displayed is patient medical information from electronic medical record system 120. Items displayed would include results and trend charts, images (x-ray/mammogram/etc), the roadmap/goals, staging information, education materials (documents to review and movies). The information may be both a superset and a subset of the information displayed on device 110. The information can be a superset in that the alternative display format of secondary display 140 can allow the provider to display more information in further detail than would be readable on device 110. The information can be a subset in that the healthcare provider may not want to display all of the information that is available about the patient in the electronic medical record system 120. For example, the provider may want to stage a presentation of information to the patient to avoid overwhelming the patient. For example, much of the information that physician presents to the patient is technical in nature, such as images with interpretations, medical jargon, lab results which individually mean nothing but combined with other information plus patient expressed symptoms lead to diagnosis, etc. Accordingly, the physician can stage the presentation of information to explain the data as it is presented and simultaneously educate patients about their illness including details about their illness, instructions for medications, timelines for treatment plans, etc.

Display 140 may further be used to display educational material geared for the patient that does not need to be displayed on device 110. A physician, viewing the device 110, may view a listing of educational materials as the actual educational materials are being displayed on the display 140. As each actual education material is displayed, the educational material in the listing can be highlighted so that the physician can know to discuss those materials with the patient.

The initial screen displayed on device 110 is the quick reference sheet to display information. Each section will be touchable by the provider, which will change the interfaces on both the provider device 110 and secondary display 140. The provider device 110 sections also have a “display on screen, but don't change the provider device 110” button, so a physician can display something to a patient without losing his summary sheet. Thus, the physician conducts an appointment using the provider device 110 and secondary display 140.

Provider device 110 is configured to recognize when the device 110 has left the proximity of display 140 in a step 214. This will most likely occur when the provider has finished talking with the patient and is moving on to the next patient. The provider may alternatively indicate using the device 110 that they wish to cease control over secondary display 140. Once the physician has completed the consult, the patient could remain in the consult room to finish watching movies and reviewing education materials. At this time, the physician could delink from the secondary display 140, and leave the queued up education materials still accessible to the user of secondary display 140. A nurse might come in to wrap up the appointment, controlling the secondary display 140 through a computer vision device such as a Kinect, an Eye Toy, etc., voice control, a touch screen, a mouse, any other type of hardware or software for receiving an input from a proximate user, such as SoundWave, manufactured by Microsoft, using Doppler effect for object detection and gesture recognition, or perhaps a second provider device 110.

Following determination that the provider has moved on or following specific instructions from device 110, electronic medical record system 120 is configured to terminate control over secondary display 140 in a step 216. Terminating control includes reverting the display 140 to the patient centric mode. At the conclusion of the appointment, all of the education materials and movies are sent to a patient accessible information archive in the patient's EMR on electronic medical record, system 120 or other secure data repository. Further, a subset of the information presented during the step 212 may be displayed on display 140 to allow the patient to review his or her treatment plan, view educational materials, save portions to his or her electronic medical record, recall for subsequent viewing, etc.

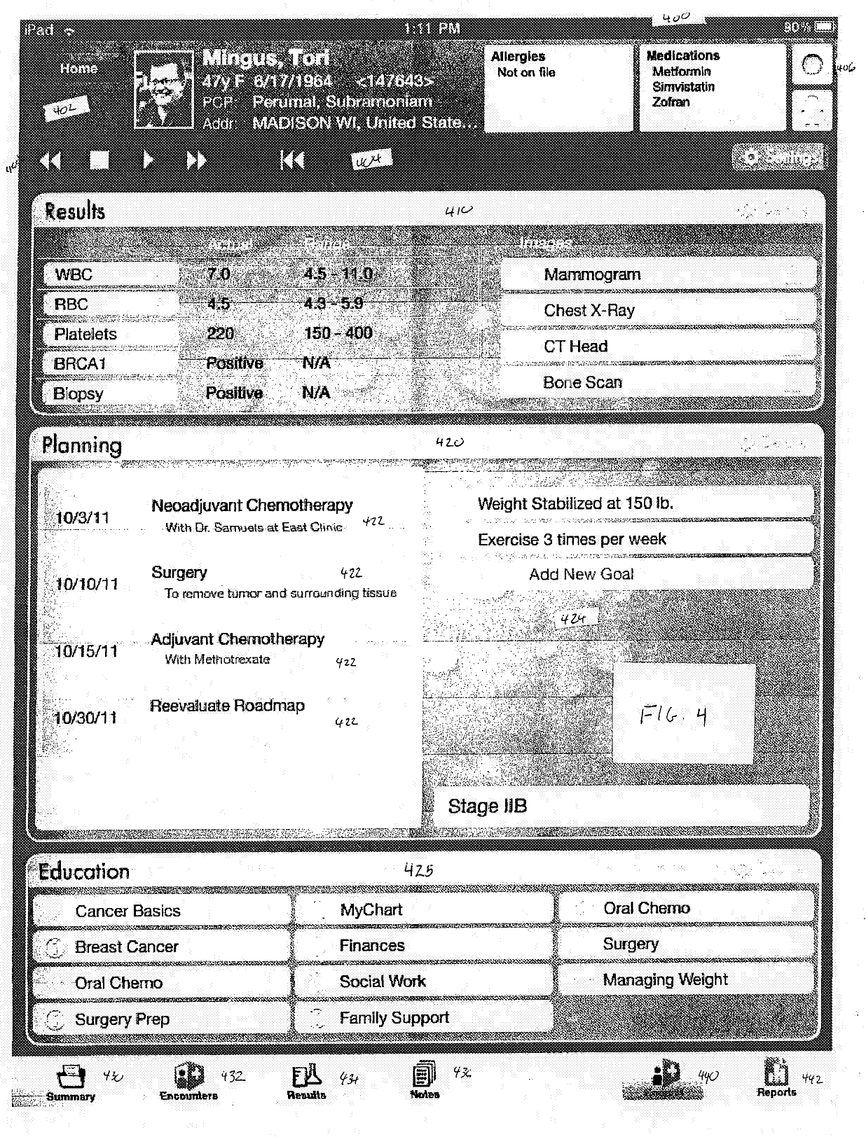

Referring now to FIG. 4, an exemplary patient roadmap interface 400 to be displayed on provider device 110 during presentation of a treatment plan to a patient is shown, according to an exemplary embodiment. Interface 400 includes a patient health information section 410, patient treatment plan section 420, and a patient education section 425.

Interface 400 further includes a patient header 402 including patient identification information. Advantageously, before initiating the display of information regarding a patient on the secondary display 140, the provider can open the patient's EMR from electronic medical record system 120 on device 110 to review information about the patient and/or his or her condition before beginning the visit. The header 402 can further include a photograph or other identifying information for verifying the identity of the patient. Header 402 can further display important information on the patient including, in the example shown, patient allergies and current medications.

Interface 400 yet further includes a secondary display control bar 404. Control bar 404 can be used to scroll through patient images, initiate and control video playback for patient education materials, etc. The control bar 404 can be expanded to display a virtual mouse pad for controlling the operation of a cursor on secondary display 140 as described above with reference to FIG. 3.

Interface 400 yet further includes a provider device 110 control, interface 406 allowing the provider to initiate video and/or audio recording using input devices in device 110. For example, selection of a microphone icon can initiate recording of a physician note. Following recording of the audio or video, device 110 is configured to display an option for the provider to transmit the record to electronic medical record system 120 for inclusion in the, patient's EMR.

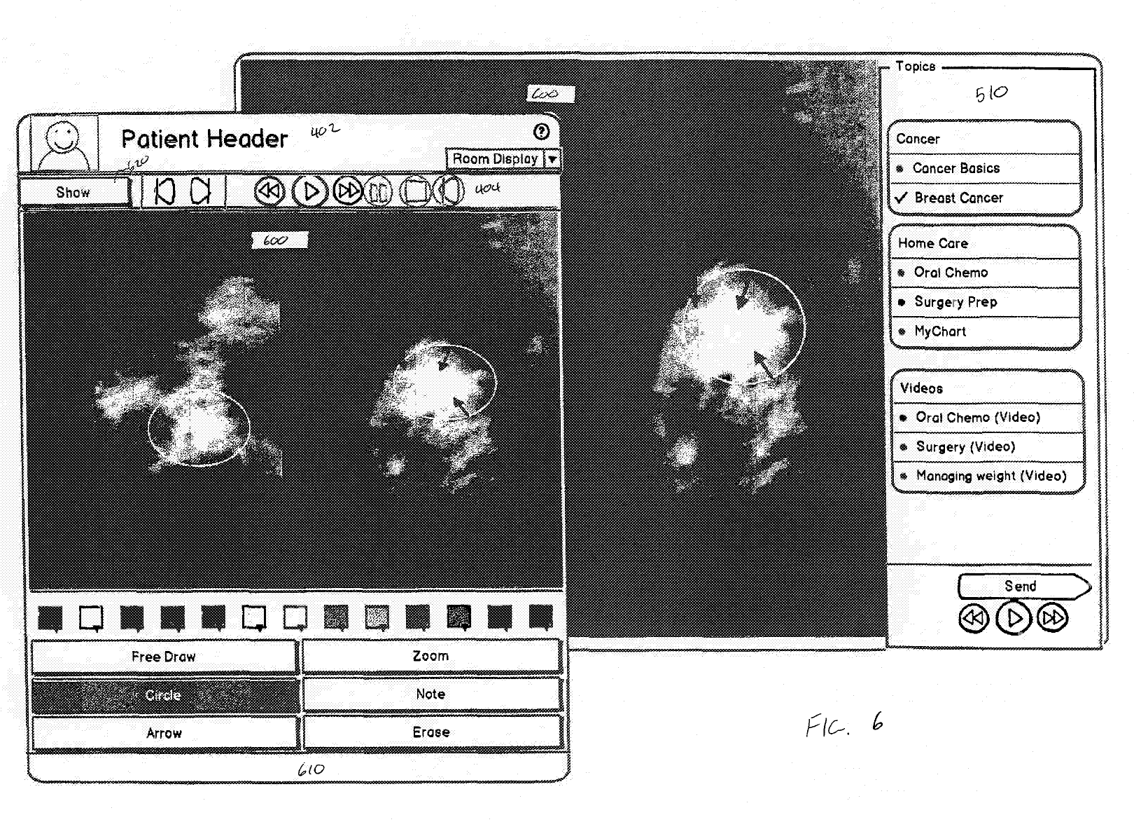

The patient health information section 410 is configured to display information needed by the provider from the patient's EMR. The data can include recent test results, images, health measurements, etc. According to an exemplary embodiment, selection of any of the values in section 410 can initiate display of detailed information about that value. For example, selection of the WBC value shown in FIG. 4 can instruct device 110 to display a detailed chart of the patient white blood cell counts over time. Selection of an image can initiate display of that image, as described in further detail below with reference to FIG. 6.

Interface 400 further includes a patient treatment plan section 420 including a plurality of patient treatment events 422. Each treatment event 422 may be a scheduled interaction with the healthcare provider over the course of treatment. For example, in the oncology example shown, the treatment plan section 422 includes treatment events 422 for a neoadjuvant chemotherapy session, a surgery, adjuvant chemotherapy, a scheduled reevaluation of the treatment plan. Treatment plan section 420 further includes a display of patient goals 424.

Patient education section 425 is configured to include links to a plurality of patient education materials. The education materials can include video, articles, images, checklists, etc. to be shared with the patient. The education materials may be selection by the provider or may be selected automatically based on a diagnosed condition of the patient, based on treatment plan events 422, based on patient goals 424, etc.

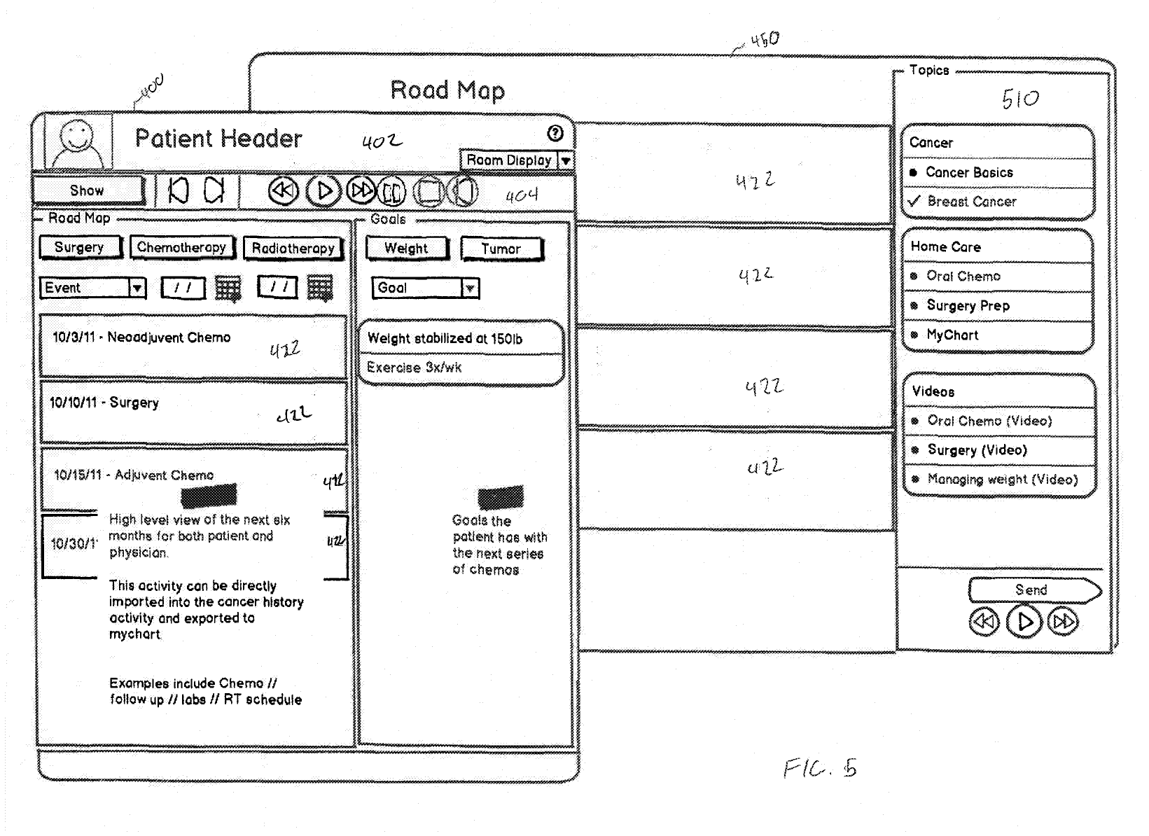

Referring now also to FIGS. 5 and 6, an education sidebar 510 may be displayed on display 140 that contains “education” materials that are automatically queued up based on, for example, patient expressed interest, physician input, nurse communication, auto-association through diagnosis, added drugs, image studies done, appointments made, events listed in FIG. 5, etc.

Interface 400 can be a complete interface to every aspect typically found in a provider's interaction with a patient and/or the patient EMR. Accordingly, interface 400 includes a summary screen icon 430 to a high level summary for the patient, an encounters icon 432 for displaying a listing of previous encounters with the patient, a results icon 434 for accessing medical testing results from the patient's EMR, a notes icon 436 for displaying a note creation interface allowing the provider to create notes displayed with the patient's EMR information on device 110, a consultation icon 440 for display of a patient consultation screen to be used in presenting a treatment plan to the patient as shown in FIG. 4, and a patient reports icon 442 for accessing medical reports from the patient's EMR.

Referring now to FIG. 5, a patient roadmap interface 400 and second display interface 450 to be displayed on provider device 110 and secondary display 140, respectively based on a selection from interface 400, in presenting a treatment plan to a patient are shown, according to an exemplary embodiment. Interfaces 400 and 450 can be used to manage physician patient interaction, particularly during the presentation and coordination of a patient treatment plan for ongoing treatment of a medical condition. For example, in oncology, the first appointment with a patient is a consult. This appointment is a 1 hour in-depth review with a patient to bring them to terms with their cancer, plan for the future, and educate them. The consult is a very patient focused appointment, where a physician needs quick access to data, yet can't spend time searching for information since the patient needs to feel as if all attention is being directed at him or her.

As shown in FIG. 5, interface 450 can be used to display those items from interface 400 that the provider indicates are to be displayed to the patient For example, each of the treatment plan events 422 are displayed on interface 450. However, treatment plan interface 420 may be configured to allow the creation of new healthcare events 422, icons for displaying a selection of different types of events, such as the surgery, chemotherapy and radiotherapy icons shown, etc. Further, display 400 may be configured to display provider notes 436 that are not displayed on secondary display 450.

Advantageously, displays 400 and 450 may be used to allow a physician to provide more standardized treatment to patients. The device 400 can be used to facilitate the presentation of a detailed treatment plan to the patient. A detailed walkthrough of an oncology treatment plan, including the ability to select from multiple different courses of treatment, scheduling options, etc. can be displayed to the provider on the device 110 without being displayed to the patient. As the provider moves through the various steps of the treatment plan formation, display 450 can be updated to include the evolving treatment, plan. Although the provider is providing a standardized treatment plan, the patient can participate in the planning and goal setting process and view the evolving treatment plan on display 450. The goals specifically are patient specific based on the patient's current health, based on, for example lab results, measurements, etc. and his or her target health.

Referring now to FIG. 6, provider device 110 and secondary display device 140 can be used to review patient medical images 600 selected from patient health information section 410. The patient medical images 600 can be retrieved from or through the electronic medical record system 120 such that the same patient medical image 600 is display on device 110 and display 140. Retrieving a medical image through the EMR can include retrieving an identifier for an, image stored in a network accessible picture archiving and communication system.

Device 110 further includes an image manipulation toolset 610, including standard image drawing tools such as free drawing, circles, arrows, zoom, notes, and erasing. The provider can make annotations to the image 600 being displayed on device 110. The provider may also be provided with an option to save the annotated image to the patient's EMR.

When satisfied, the provider can click a “display to patient” icon 620 to transmit the annotations to electronic medical record system 120 for display on secondary display 140. Alternatively, the provider may indicate a desire to display the image by selecting the image and moving the image from a device 110 section to a display 140 section of an interface, such as the interface shown in FIG. 3. The provider may further “fling” the image from the device 110 to the display 140 by selecting the image and moving their finger rapidly along a touch screen to, the edge of device 110.

In an alternative embodiment, the drawing toolset 610 may also be displayed on secondary display 140. The patient, when asking questions about the images, can submit his or her own annotations for communication to device 110 through electronic medical record system 120.

Generally, the term “queue” should not be considered to require any particular data structure but only data that provides for the functionality described above. When the terms “physician” or “doctor” are used herein, they should be considered to include healthcare professionals generally, including nurses and physician assistants.

Certain terminology is used herein for purposes of reference only, and thus is not intended to be limiting. For example, terms such as “display device” refer to any computer system or display type for displaying received information. Terms such as program, interface, workstation are intended to provide contextual information for understanding the type of computing systems that may be used to implement the concepts described herein and are not intended to limit the present invention to specific hardware implementations. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a server” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network. It should be understood that a computer program may embrace constituent programs and that multiple programs may be implemented as a single or multiple programs.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A computer implemented system for displaying patient medical data during an interaction between a patient and a healthcare provider, comprising:
a healthcare provider computing device configured to receive identification of a patient;
a secondary display device; and
an electronic medical record system server configured to
receive an identification of the patient transmitted from the healthcare provider computing device and provide access to patient medical data in an electronic medical record through the healthcare provider computing device, and
display information from the electronic medical record on the secondary display based on a command received from the healthcare provider computing device.

2. The system of claim 1, wherein the electronic medical record system is configured to transmit an activation key to the secondary display device for display on the secondary display device.

3. The system of claim 2, wherein the provider computing device is configured to require entry of the activation key prior to displaying information from the electronic medical record on the secondary display.

4. The system of claim 1, wherein the information is medical image data and the medical image data is displayed on the provider computing device as well as the secondary display device.

5. The system of claim 4, wherein the provider computing device is configured to provide an annotation toolset for making modifications to the medical image data.

6. The system of claim 5, wherein modifications to the medical image data on the provider computing device are transmitted to the electronic medical record system server for storage in the electronic medical record.

7. The system of claim 6, wherein modifications to the medical image data are displayed on the secondary display based on a selection by the user of the provider computing device.

8. The system of claim 7, wherein the secondary display device also provides an annotation toolset for making modifications to the medical image data.

9. The system of claim 1, wherein the provider computing device is configured to display a treatment plan template including a plurality of selectable treatment plan events and selection of a treatment plan event transmits a signal to the electronic medical record system server to display the treatment plan event on the secondary display device.

10. A computer implemented method for displaying patient medical data during an interaction between a patient and a healthcare provider, comprising:
receiving an identification of a patient at an electronic medical record server;
transmitting patient medical data from an electronic medical record associated with the identified patient to the healthcare provider computing device;
identifying a location of the provider computing device;
transmitting an activation key to a secondary display device for display on the secondary display device;
receiving confirmation from the healthcare provider computing device that the activation key was entered into the healthcare provider computing device; and
displaying information from the electronic medical record on the secondary display based on a command received from the healthcare provider computing device.

11. The method of claim 10, wherein the information is medical image data and the medical image data is displayed on the provider computing device as well as the secondary display device.

12. The method of claim 11, wherein the provider computing device is configured to provide an annotation toolset for making modifications to the medical image data.

13. The method of claim 12, wherein modifications to the medical image data on the provider computing device are transmitted to the electronic medical record system server for storage in the electronic medical record.

14. The method of claim 13, wherein modifications to the medical image data are displayed on the secondary display based on a selection by the user of the provider computing device.

15. The method of claim 14, wherein the secondary display device also provides an annotation toolset for making modifications to the medical image data

16. The method of claim 10, wherein the provider computing device is configured to display a treatment plan template including a plurality of selectable treatment plan events and selection of a treatment plan event transmits a signal to the electronic medical record system server to display the treatment plan event on the secondary display device.

17. A computer implemented method for displaying patient medical data during an interaction between a patient and a healthcare provider, comprising:
receiving an identification of a patient at an electronic medical record server;
transmitting patient medical data from an electronic medical record associated with the identified patient to the healthcare provider computing device;
identifying a location of the provider computing device;
identifying a secondary display device based on the location of the provider computing device; and
displaying information from the electronic medical record on the secondary display based on a command received from the healthcare provider computing device.

18. The method of claim 17, wherein the information is medical image data and the medical image data is displayed on the provider computing device as well as the secondary display device.

19. The method of claim 18, wherein the provider computing device is configured to provide an annotation toolset for making modifications to the medical image data.

20. The method of claim 19, wherein modifications to the medical image data on the provider computing device are transmitted to the electronic medical record system server for storage in the electronic medical record.

21. The method of claim 20, wherein modifications to the medical image data are displayed, on the secondary display based on a selection by the user of the provider computing device.

22. The method of claim 21, wherein the secondary display device also provides an annotation toolset for making modifications to the medical image data.

23. The method of claim 17, wherein the provider computing device is configured to display a treatment plan template including a plurality of selectable treatment plan events and selection of a treatment plan event transmits a signal to the electronic medical record system server to display the treatment plan event on the secondary display device.
